(19) United States
(12) Patent Application Publication
(10) Pub. No.: US 2022/0381154 A1
(43) Pub. Date: Dec. 1, 2022

(54) FLUSHING METHOD FOR LUBRICATING OIL SYSTEM, FLUSHING APPARATUS, AND FLUSHING SYSTEM

(71) Applicant: MITSUBISHI HEAVY INDUSTRIES, LTD., Tokyo (JP)

(72) Inventors: Youhei Tsuchiya, Tokyo (JP); Takashi Haneishi, Tokyo (JP)

(73) Assignee: MITSUBISHI HEAVY INDUSTRIES, LTD., Tokyo (JP)

(21) Appl. No.: 17/591,248

(22) Filed: Feb. 2, 2022

(30) Foreign Application Priority Data
May 28, 2021 (JP) 2021-090616

(51) Int. Cl. F01D 25/18; F16N 39/06; F16N 19/00; F16N 7/38

(52) U.S. Cl. CPC F01D 25/18; F16N 39/06; F16N 19/00; F16N 7/38; F16N 2210/02; F05D 2220/31; F05D 2260/98

(57) ABSTRACT

A flushing method for a lubricating oil system includes a step of performing precedent inside oil flushing for bearing box, by connecting an oil supply pipe and a flushing apparatus mounted to a bearing box to each other by a bypass pipe while bypassing an internal pipe that is provided in the bearing box and introduces an oil supplied from the oil supply pipe to a part between a rotor of a turbine and a bearing, supplying the oil from the oil supply pipe to the flushing apparatus through the bypass pipe, and injecting the oil from the flushing apparatus into the bearing box, to thereby perform oil flushing for the inside of the bearing box; and a final oil flushing step of supplying the oil from the oil supply pipe to an internal pipe, to thereby perform oil flushing for the inside of the lubricating oil system, after the step of performing precedent inside oil flushing for bearing box.

### BACKGROUND OF THE INVENTION

### 1. Field of the Invention

The present invention relates to a flushing method for a lubricating oil system of a turbine in a power generation plant, and a flushing apparatus and a flushing system used for carrying out the flushing method.

### 2. Description of the Related Art

In a power generation plant, an inspection is conducted periodically. While the routine inspection is performed, the operation of the power generation plant is stopped. Therefore, shortening of the number of days required for the routine inspection is desired. In the routine inspection, an overhaul of the turbine is conducted. After the overhaul is finished, oil flushing in which an oil is circulated in a lubricating oil system for a bearing of the turbine to thereby recover a foreign material in the lubricating oil system is performed (see Patent Document 1).

Patent Document 1 discloses a flushing method for a lubricating oil system in which an oil is made to flow from an oil tank to a bearing of the turbine and is returned to the oil tank. In the flushing method described in Patent Document 1, an oil tank flushing system in which the oil in the oil tank is passed through an oil purifying filter and is returned to the oil tank is provided separately from the lubricating oil system, and precedent oil flushing for the oil tank by the oil tank flushing system is conducted during an overhaul of the turbine. After the overhaul of the turbine is finished and the turbine is assembled, the oil in the oil tank which is purified by the precedent oil flushing is made to flow in the lubricating oil system for the bearing of the turbine, and the oil is passed through the oil purifying filter, whereby final oil flushing for the lubricating oil system for the bearing of the turbine is performed.

### PRIOR ART DOCUMENT

### Patent Document

Patent Document 1: JP-1998-252418-A

In the flushing method described in Patent Document 1, precedent oil flushing for the oil tank is conducted during an overhaul of the turbine, prior to the final oil flushing for the lubricating oil system. However, since the bearing box accommodating the bearing of the turbine is opened in the overhaul of the turbine, foreign materials such as dust and sand dust may enter into the bearing box. Therefore, in the final oil flushing for the lubricating oil system that is carried out after assembly of the turbine, it is difficult to sufficiently remove in a short time the foreign material entered into the bearing box during the overhaul of the turbine.

It is an object of the present invention to speedily recover the foreign material in the bearing box and to shorten the final oil flushing step.

### SUMMARY OF THE INVENTION

A flushing method for a lubricating oil system according to a mode of the present invention is a flushing method for a lubricating oil system of a turbine in a power generation plant, the lubricating oil system having an oil tank in which an oil is reserved, an oil pump that sucks the oil in the oil tank and delivers the oil, a bearing box accommodating a bearing of the turbine, an oil supply pipe that is connected to the oil tank and the bearing box and supplies the oil delivered from the oil pump to the bearing box, an internal pipe that is provided in the bearing box and introduces the oil supplied from the oil supply pipe to a part between a rotor of the turbine and the bearing, an oil discharge pipe that is connected to the bearing box and the oil tank and introduces the oil discharged from the bearing box to the oil tank, and a strainer provided in the oil supply pipe, the flushing method including a step of performing precedent inside oil flushing for bearing box, by connecting the oil supply pipe and a flushing apparatus mounted to the bearing box to each other by a bypass pipe while bypassing the internal pipe, supplying the oil from the oil supply pipe to the flushing apparatus through the bypass pipe, and injecting the oil from the flushing apparatus into the bearing box, to thereby perform oil flushing for an inside of the bearing box; and a final oil flushing step of supplying oil from the oil supply pipe to the internal pipe, to thereby perform oil flushing for an inside of the lubricating oil system, after the step of performing precedent inside oil flushing for bearing box.

According to the present invention, the foreign material in the bearing box can be swiftly recovered, and the final oil flushing step can be shortened.

### BRIEF DESCRIPTION OF THE DRAWINGS

FIG. 1 is a system diagram depicting an example of a lubricating oil system of a turbine in a power generation plant;

FIG. 2 is a diagram describing a technique 1 of precedent oil flushing;

FIG. 3A is a diagram describing a technique 2-1 of precedent oil flushing;

FIG. 3B is a diagram describing a technique 2-2 of precedent oil flushing;

FIG. 4 is a diagram describing a foreign material penetrating into a bearing stand while a bearing box is open;

FIG. 5 is a diagram depicting the flow of an oil flowing in the bearing box, in a final oil flushing step;

FIG. 6 is a diagram depicting the configuration of a flushing system according to the present embodiment;

FIG. 7 is a side sectional schematic view of the bearing box, depicting the configuration of a flushing apparatus according to the present embodiment;

FIG. 8 is a diagram describing the carrying-out procedure of the flushing method for a lubricating oil system according to the present embodiment (lower part of the diagram) and describing the carrying-out procedure of a flushing method for a lubricating oil system according to Comparative Example of the present embodiment (upper part of the diagram);

FIG. 9 is a flow chart depicting an example of the carrying-out procedure of a step of precedent inside oil flushing for bearing box; and

FIG. 10 is a side sectional schematic view of the bearing box, depicting a flushing apparatus according to Modification 1 of the present embodiment.

### DESCRIPTION OF THE PREFERRED EMBODIMENT

A flushing system according to an embodiment of the present invention will be described referring to the drawings. In the present embodiment, a flushing system for a lubricating oil system for a bearing supporting a turbine of steam turbine equipment is described as an example.

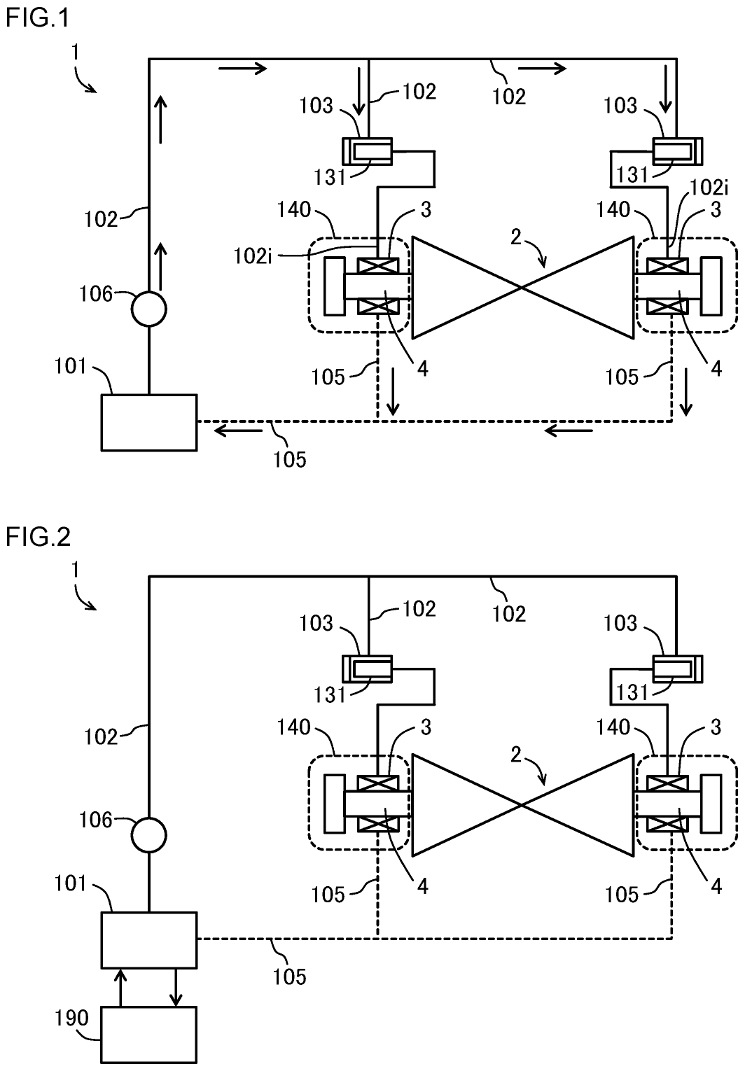

FIG. 1 is a system diagram depicting an example of a lubricating oil system 1 of a turbine in a power generation plant. The lubricating oil system 1 of the turbine has an oil tank 101 in which an oil is reserved; an oil pump 106 that sucks the oil in the oil tank 101 and delivers the oil; a bearing box 140 accommodating a bearing 3 that rotatably supports a rotor 4 of the turbine 2; an oil supply pipe 102 that is connected to the oil tank 101 and the bearing box 140 and supplies the oil delivered from the oil pump 106 to the bearing box 140; an internal pipe 102i that is provided in the bearing box 140 and introduces the oil supplied from the oil supply pipe 102 to a part between the rotor 4 of the turbine 2 and the bearing 3; an oil discharge pipe 105 that is connected to the bearing box 140 and the oil tank 101 and introduces the oil discharged from the bearing box 140 to the oil tank 101; and a strainer 103 provided in the oil supply pipe 102.

The oil supply pipe 102 is connected to the internal pipe 102i in the bearing box 140 (see FIG. 5). The internal pipe 102i introduces the oil supplied from the oil supply pipe 102 to a part between the rotor 4 of the turbine 2 and the bearing 3, through the bearing 3 and an internal passage formed in a bearing holding member 5 (see FIG. 5). As a result, the bearing 3 is lubricated. Thus, the oil in the oil tank 101 is used as a lubricating oil for the bearing 3 of the turbine 2. The oil introduced to the bearing 3 is collected in the bearing box 140, and is returned into the oil tank 101 through the oil discharge pipe 105.

Note that, while only one turbine 2 is depicted in FIG. 1, the steam turbine equipment may include, as a steam turbine, a plurality of turbines such as a high-pressure turbine and a low-pressure turbine that are driven by steams different in pressure level.

Thus, the lubricating oil system 1 constitutes a circulation system in which the oil in the oil tank 101 is supplied to the bearing 3 in the bearing box 140 through the oil supply pipe 102 by power of the oil pump 106 and the oil discharged from the bearing box 140 is returned to the oil tank 101 through the oil discharge pipe 105.

The strainer 103 is provided between the oil pump 106 in the lubricating oil system 1 and the bearing 3 of the turbine 2. A permanent foreign material capture member 131 formed by a punching plate or the like is provided in the strainer 103. The strainer 103 captures the foreign material contained in the oil in the lubricating oil system 1 during operation of the power generation plant. The foreign material contained in the lubricating oil system 1 is, for example, staying matter in the oil tank 101, oxide products called sludge generated in the lubricating oil system 1, abrasion powder, dust and sand dust penetrating into the bearing box 140 which is put into an open state during a construction period and an inspection period, or the like.

When the overhaul of the turbine 2 is completed in a routine inspection of the power generation plant, oil flushing of the lubricating oil system 1 is conducted prior to the start of operation. In the oil flushing of the lubricating oil system 1 after the overhaul, in place of or in addition to the permanent foreign material capture member 131, a temporary foreign material capture member (not illustrated) such as a finer meshing (meshing with larger number of mesh) is mounted in the strainer 103, and the oil pump 106 is driven, to circulate the oil in the lubricating oil system 1. As a result, the foreign material is recovered in the strainer 103, and the oil in the lubricating oil system 1 is clarified.

The above-mentioned oil flushing is started after the assembly work of the turbine 2 is completed and the lubricating oil system 1 is restored, and, therefore, the oil flushing may be a critical path on a step basis before a trial run which is the next step. Therefore, it is preferable to contrive shortening of the time required for oil flushing after the assembly work of the turbine 2, by carrying out the oil flushing for a part of the lubricating oil system 1, prior to the above-mentioned oil flushing and before the assembly work of the turbine 2 is completed (for example, during the overhaul of the turbine 2). Hereinafter, the oil flushing carried out before the assembly work of the turbine 2 is completed will be referred to as “precedent oil flushing,” and the final oil flushing carried out after the assembly work of the turbine 2 is completed will be referred to as “final oil flushing.”

For the precedent oil flushing, for example, Technique 1 and Technique 2 that follow can be adopted.

### <Technique 1> Precedent Inside Oil Flushing for Tank

Technique 1 of precedent oil flushing will be described referring to FIG. 2. As depicted in FIG. 2, Technique 1 is a technique in which, during the overhaul of the turbine 2, an oil purifier 190 having a high flushing ability is temporarily connected to the oil tank 101 and the foreign material in the oil tank 101 is removed prior to the assembly work of the turbine 2. Since Technique 1 is a technique in which the oil is circulated between the inside of the oil tank 101 and the oil purifier 190, Technique 1 can be carried out during the overhaul of the turbine 2.

### <Technique 2> Precedent Inside Oil Flushing for System

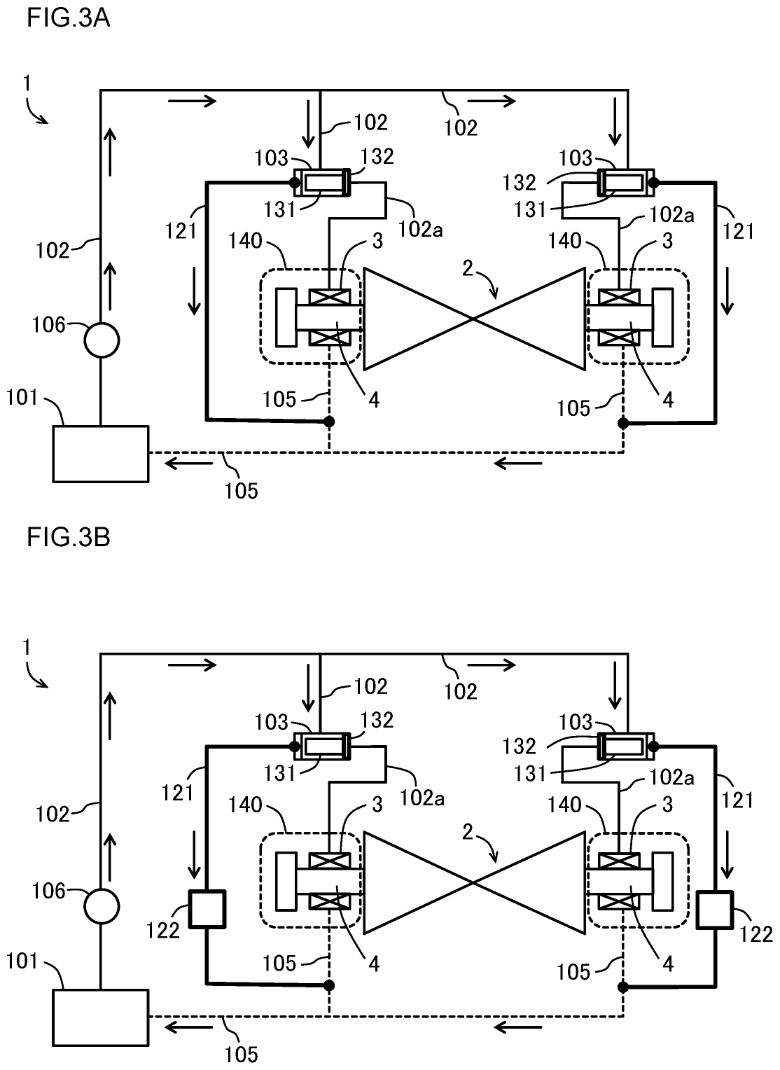

Technique 2 of precedent oil flushing will be described referring to FIGS. 3A and 3B. As depicted in FIGS. 3A and 3B, Technique 2 is a technique in which, during the overhaul of the turbine 2, the oil supply pipe 102 and the oil discharge pipe 105 are connected to each other by a temporary bypass pipe 121 that has flexibility, while bypassing the bearing box 140, and foreign material in the lubricating oil system 1 exclusive of the inside of the bearing box 140 and the surroundings thereof is removed. Since Technique 2 is a technique in which the oil is made to flow from the oil supply pipe 102 to the oil discharge pipe 105 while bypassing the bearing box 140, Technique 2 can be carried out during the overhaul of the turbine 2. Technique 2 includes, for example, Technique 2-1 (see FIG. 3A) and Technique 2-2 (see FIG. 3B) that follow.

### <Technique 2-1>

In Technique 2-1, as depicted in FIG. 3A, a closing plate 132 is mounted to an opening which is an oil outlet of the strainer 103 during operation of the power generation plant. As a result, the oil is not supplied to an oil feed pipe 102a which is the oil supply pipe 102 connecting the strainer 103 and the internal pipe 102i in the bearing box 140 to each other. The strainer 103 has a connection part to which the bypass pipe 121 is connected. The bypass pipe 121 is mounted to the connection part of the strainer 103 and the oil discharge pipe 105. The oil delivered from the oil pump 106 is introduced to the bypass pipe 121 through the oil supply pipe 102 and the strainer 103. The oil introduced to the bypass pipe 121 is returned to the oil tank 101 through the oil discharge pipe 105. The oil is circulated through the path of the oil tank 101, the oil supply pipe 102, the strainer 103, the bypass pipe 121, the oil discharge pipe 105, the oil tank 101, in this order. As a result, the foreign material can be captured by the strainer 103, and can be recovered. In Technique 2-1, like in the final oil flushing, the foreign material is recovered by the permanent strainer 103.

### <Technique 2-2>

Technique 2-2 is a technique similar to Technique 2-1, but is different in that a temporary strainer 122 is provided in the bypass pipe 121 as shown in FIG. 3B. Like the permanent strainer 103, the temporary strainer 122 includes a foreign material capture member that captures the foreign material. In Technique 2-2, by additionally providing the temporary strainer 122 to the bypass pipe 121, a flushing ability is augmented. Therefore, in Technique 2-2, the time required for precedent oil flushing can be shortened as compared to Technique 2-1.

Thus, by carrying out the precedent oil flushing for a part of the lubricating oil system 1, the time for the final oil flushing can be shortened.

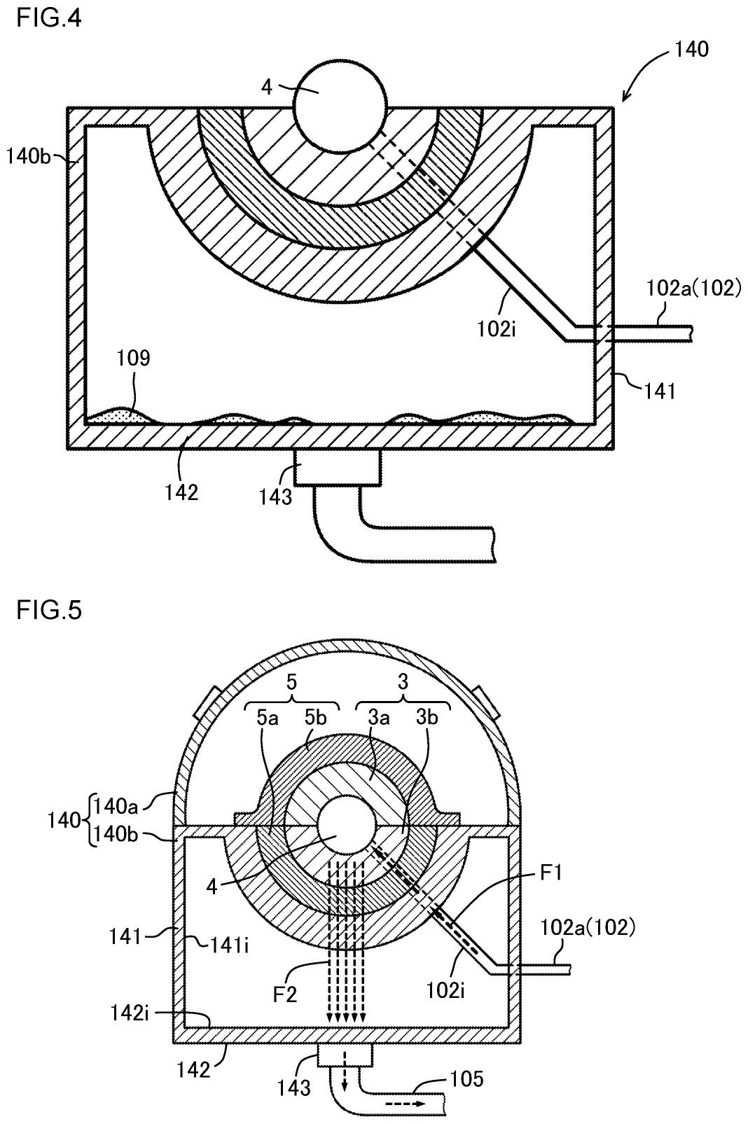

However, by the precedent oil flushing by Technique 1 and Technique 2, the foreign material in the bearing box 140 cannot be removed. As depicted in FIG. 4, the bearing box 140 is opened at the time of the overhaul of the turbine 2. Therefore, during the overhaul of the turbine 2, foreign materials 109 such as dust and sand dust may penetrate into the bearing box 140. These foreign materials 109 cannot be recovered by the precedent oil flushing by Technique 1 and Technique 2.

The precedent oil flushing by Technique 1 and Technique 2 has an unopened part as an object thereof, and the bearing box 140 which is an opened part is not included in the object. Therefore, for recovering sufficiently the foreign materials 109 in the bearing box 140 in the final oil flushing, much time is required.

In addition, in the final oil flushing, in the case of using permanent equipment, as depicted in FIG. 5, the oil (see an arrow F1) supplied from the internal pipe 102i to a part between the bearing 3 and the rotor 4 in the bearing box 140 flows down to directly below the bearing 3 due to gravity (see an arrow F2), and is introduced from an oil outlet box 143 provided at a bottom plate 142 of the bearing box 140 to the oil discharge pipe 105. Besides, this flow of the oil is weak in vigor. Therefore, in the final oil flushing, it is difficult to remove the foreign material deposited on an inner surface (hereinafter, also referred to as an inside surface) 141i of a side plate 141 of the bearing box 140 and the foreign material accumulated in corner parts and the like of an upper surface (hereinafter, also referred to as a bottom surface) 142i of the bottom plate 142. As a result, in the final oil flushing, much time is required to sufficiently remove the foreign material in the bearing box 140, and room for improvement lies in that point.

In view of this, in the present embodiment, in order to remove the foreign material in the bearing box 140 in a short time, a flushing system 10 including a flushing apparatus 150 described below is adopted.

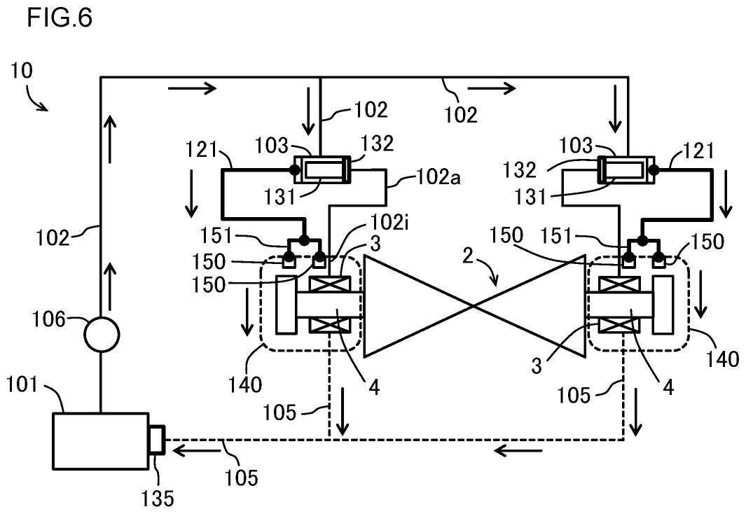

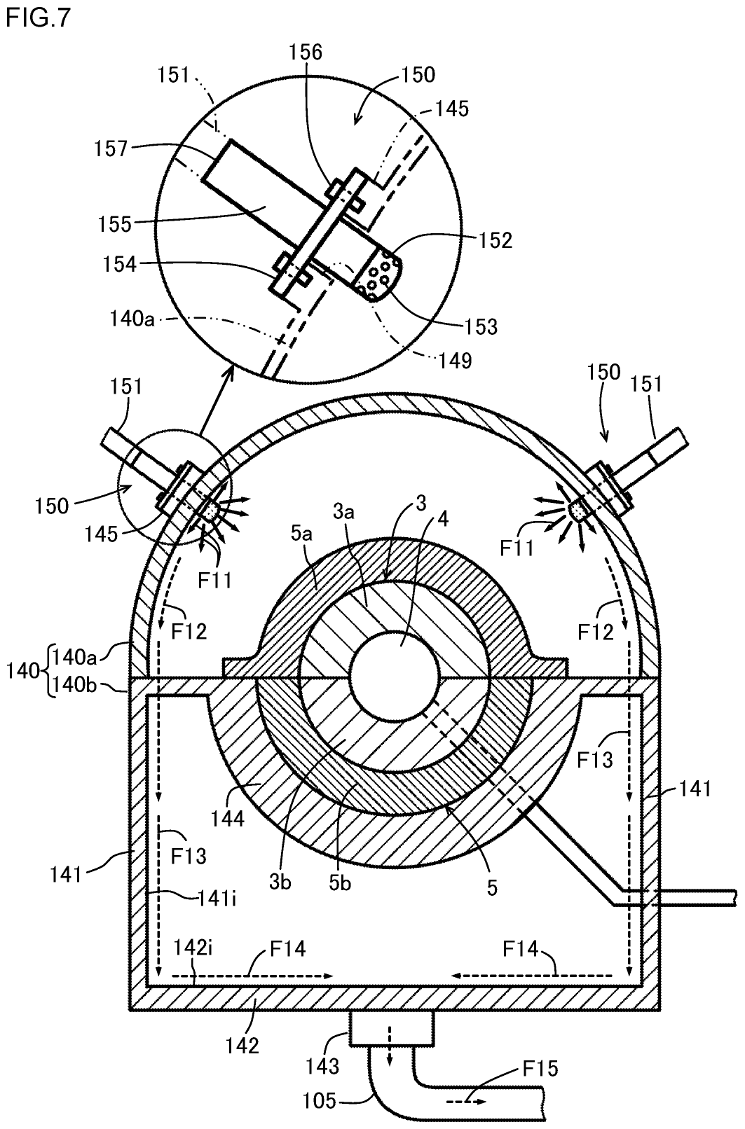

The flushing system 10 including the flushing apparatus 150 according to the present embodiment will be described in detail below, referring to FIGS. 6 and 7. FIG. 6 is a diagram depicting the configuration of the flushing system 10 according to the present embodiment. As depicted in FIG. 6, the flushing system 10 includes the oil tank 101 in which an oil is reserved; the oil pump 106 that sucks the oil in the oil tank 101 and delivers the oil; the bearing box 140 accommodating the bearing 3 of the turbine 2; the oil supply pipe 102 that is connected to the oil tank 101 and the bearing box 140 and supplies the oil delivered from the oil pump 106 to the bearing box 140; the oil discharge pipe 105 that is connected to the bearing box 140 and the oil tank 101 and introduces the oil discharged from the bearing box 140 to the oil tank 101; the strainer 103 provided in the oil supply pipe 102; the flushing apparatus 150 mounted to the bearing box 140; and the bypass pipe 121 connected to the strainer 103 provided in the oil supply pipe 102 and the flushing apparatus 150, while bypassing the internal pipe 102i in the bearing box 140, the internal pipe 102i introducing the oil supplied from the oil supply pipe 102 to a part between the rotor 4 of the turbine 2 and the bearing 3.

The bearing box 140 and the flushing apparatus 150 will be described referring to FIG. 7. FIG. 7 is a side sectional schematic view of the bearing box 140, and depicts the configuration of the flushing apparatus 150 according to the present embodiment. Note that an example in which two flushing apparatuses 150 are provided in one bearing box 140 is described in the present embodiment, but only one flushing apparatus 150 may be provided in one bearing box 140, or three or more flushing apparatuses 150 may be provided in one bearing box 140.

As depicted in FIG. 7, the bearing box 140 has a bearing stand 140b that supports the bearing 3 of the turbine 2 in the power generation plant from the lower side, and a bearing cover 140a that is provided on the upper side of the bearing stand 140b and covers the bearing 3. For example, the bearing stand 140b is in the shape of a rectangular box opened at an upper part, and has the bottom plate 142 and a plurality of side plates 141 rising from end parts of the bottom plate 142. In addition, a plurality of support plates 144 supporting the bearing 3 are disposed on the bearing stand 140b.

The bearing cover 140a is, for example, semi-cylindrical in shape, and is provided with a flange part (not illustrated) at a lower end part. The flange part of the bearing cover 140a is fastened to an upper end part of the bearing stand 140b by fastening members (not illustrated) such as bolts, whereby the bearing cover 140a is fixed to the bearing stand 140b.

The bearing 3 has a split structure in which the bearing 3 is split into an upper bearing 3a and a lower bearing 3b. The bearing 3 is held by the bearing holding member 5, and is supported by the bearing stand 140b through the bearing holding member 5. Like the bearing 3, the bearing holding member 5 has a split structure in which the bearing holding member 5 is split into an upper holding part 5a and a lower holding part 5b. The upper holding part 5a is fixed to the bearing stand 140b by fastening members (not illustrated) such as bolts.

The flushing apparatus 150 has a cylindrical tube part 155 extending rectilinearly, an oil inlet part 157 provided on a base end side of the tube part 155, an injection nozzle 152 provided on a tip side of the tube part 155, and an annular mounting part 154 provided such as to project to outside from the tube part 155. The tube part 155 is formed in such a size as to be able to be inserted in and passed through an opening 149 of the bearing cover 140a.

The mounting part 154 is a part mounted to the bearing cover 140a, and is fastened to a peripheral edge part of the opening 149 provided in the bearing cover 140a by fastening members 156 such as bolts. In the present embodiment, the mounting part 154 is mounted to a spare pipe stand (seat) 145 for connection of piping. With the mounting part 154 mounted to the peripheral edge part of the opening 149, the injection nozzle 152 is disposed on a center axis of the opening 149 of the bearing cover 140a. The oil inlet part 157 is a part supplied with an oil, and a connection hose 151 having flexibility is attached thereto. The connection hose 151 is connected to the bypass pipe 121 through a branch pipe (not illustrated) (see FIG. 6). As a result, the oil supplied to the bypass pipe 121 can be distributed to each flushing apparatus 150.

The injection nozzle 152 has a plurality of injection holes 153 through which the oil supplied to the oil inlet part 157 is injected into the bearing box 140. The plurality of injection holes 153 include injection holes formed such that an opening surface of an outer surface of the injection nozzle 152 faces the bearing 3. In addition, the plurality of injection holes 153 include injection holes formed such that the opening surface of the outer surface of the injection nozzle 152 faces an inner wall surface of the bearing cover 140a. In other words, the plurality of injection holes 153 include injection holes each having a center axis extending so as to have the bearing 3 located thereon, and injection holes each having a center axis extending so as to have the bearing cover 140a located thereon. The injection nozzle 152 is disposed on the upper side than a center axis of the rotor 4. In the present embodiment, the injection nozzle 152 is disposed on the upper side than the bearing 3. As will be described later, the flushing apparatus 150 injects the oil from the injection holes 153 of the injection nozzle 152 into the bearing box 140, to thereby perform oil flushing for the inside of the bearing box 140.

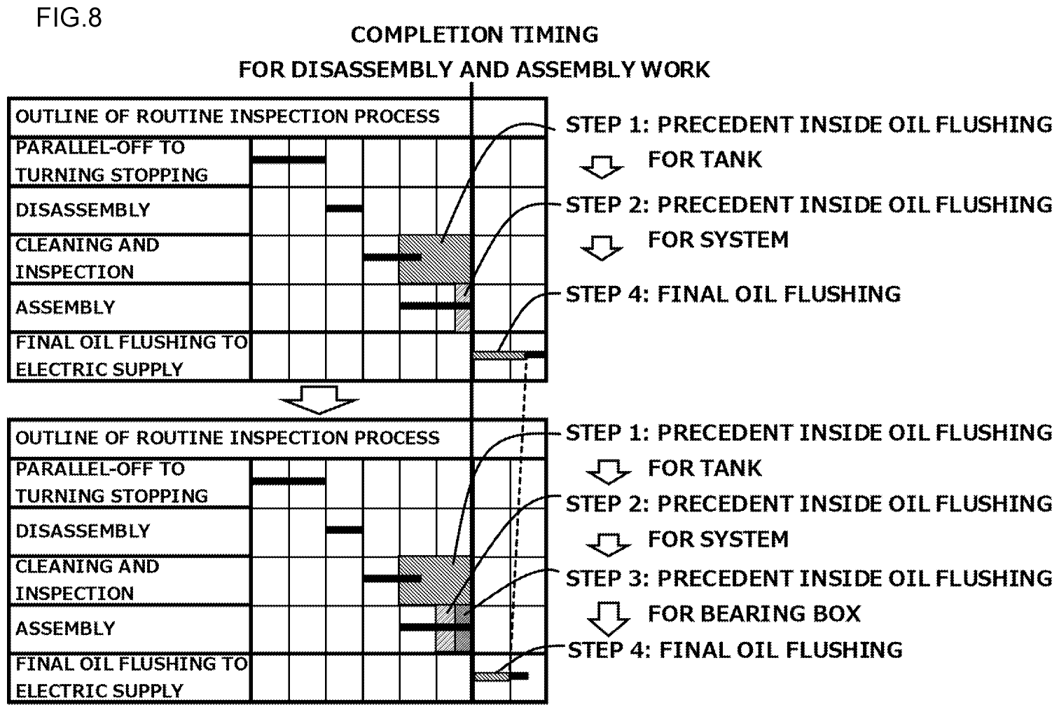

Next, an example of the flushing method for the lubricating oil system according to the present embodiment will be described, referring to FIGS. 7 to 9. The flushing system 10 including the above-mentioned flushing apparatus 150 is used for carrying out the flushing method described below. FIG. 8 is a diagram describing the carrying-out procedure of the flushing method for the lubricating oil system according to the present embodiment (lower part of the diagram) and describing the carrying-out procedure of a flushing method for a lubricating oil system according to Comparative Example of the present embodiment (upper part of the diagram). Note that FIG. 8 also depicts an outline of steps of a routine inspection. The routine inspection is conducted in the order of a parallel-off step, a turning stopping step, a disassembly step, a cleaning and inspection step, an assembly step, a final oil flushing step, and an electric supply step.

As depicted in the lower part of FIG. 8, in the flushing method for the lubricating oil system according to the present embodiment, a step of precedent inside oil flushing for tank (Step 1), a step of precedent inside oil flushing for system (Step 2), a step of precedent inside oil flushing for bearing box (Step 3), and a final oil flushing step (Step 4) are performed in this order. Note that, as depicted in the upper part of FIG. 8, in the flushing method for the lubricating oil system according to Comparative Example of the present embodiment, the step of precedent inside oil flushing for bearing box (Step 3) of the flushing method for the lubricating oil system according to the present embodiment is omitted. Steps 1 to 4 are carried out by one or more operators.

### —Step of Precedent Inside Oil Flushing for Tank—

The step of precedent inside oil flushing for tank (Step 1) is a step in which precedent oil flushing (see FIG. 2) by Technique 1 described above is conducted, that is, a step of recovering the foreign material in the oil tank 101 by the oil purifier 190. The step of precedent inside oil flushing for tank (Step 1) is started while the cleaning and inspection step in the routine inspection is being conducted, and is carried out for a predetermined period. For example, the step of precedent inside oil flushing for tank (Step 1) is performed until the final oil flushing step (Step 4) is started.

### —Step of Precedent Inside Oil Flushing for System—

The step of precedent inside oil flushing for system (Step 2) is started after a predetermined period is elapsed from the start of the step of precedent inside oil flushing for tank (Step 1). For example, the step of precedent inside oil flushing for system (Step 2) is started while the assembly step in the routine inspection is being conducted, and is carried out for a predetermined period.

The step of precedent inside oil flushing for system (Step 2) is a step in which the precedent oil flushing (FIGS. 3A and 3B) by Technique 2 described above is conducted. As depicted in FIGS. 3A and 3B, in the step of precedent inside oil flushing for system (Step 2), the operator connects the oil supply pipe 102 and the oil discharge pipe 105 to each other by the bypass pipe 121 while bypassing the bearing box 140. The operator starts the oil pump 106, and returns the oil delivered from the oil pump 106 to the oil tank 101, through the bypass pipe 121 and the oil discharge pipe 105, to thereby perform oil flushing for the inside of the lubricating oil system 1. Note that, in the precedent inside oil flushing for system (Step 2), the precedent oil flushing of either one of Technique 2-1 and Technique 2-2 is carried out. As depicted in FIG. 8, when the step of precedent inside oil flushing for system (Step 2) is completed, a step of precedent inside oil flushing for bearing box (Step 3) is started.

### —Step of Precedent Inside Oil Flushing for Bearing Box—

The step of precedent inside oil flushing for bearing box (Step 3) is started while the assembly step in the routine inspection is being conducted, and is carried out for a predetermined period. Specifically, the step of precedent inside oil flushing for bearing box is carried out sequentially starting from, of the plurality of the bearing boxes 140 in the power generation plant, the bearing box 140 for which the inspection and the assembly have been completed.

The step of precedent inside oil flushing for bearing box (Step 3) is a step in which oil flushing for the inside of the bearing box 140 by the flushing apparatus 150 is conducted (see FIGS. 6 and 7). As depicted in FIG. 6, in the step of precedent inside oil flushing for bearing box (Step 3), the operator connects the strainer 103 provided in the oil supply pipe 102 and the flushing apparatus 150 mounted to the bearing box 140 to each other by the bypass pipe 121 while bypassing the internal pipe 102i. In the present embodiment, the operator connects the bypass pipe 121 and the flushing apparatus 150 to each other by the connection hose 151. The operator starts the oil pump 106, causes the oil delivered from the oil pump 106 to be supplied to the flushing apparatus 150 through the oil supply pipe 102, the bypass pipe 121, and the connection hose 151, and causes the oil to be injected from the flushing apparatus 150 into the bearing box 140, to thereby perform oil flushing for the inside of the bearing box 140. The details of the step of precedent inside oil flushing for bearing box (Step 3) will be described later. As depicted in FIG. 8, when the step of precedent inside oil flushing for bearing box (Step 3) is completed, the operation proceeds to the final oil flushing step (Step 4).

### —Final Oil Flushing Step—

The final oil flushing step (Step 4) is a step in which the above-mentioned final oil flushing (see FIGS. 1 and 5) is performed. The final oil flushing step (Step 4) is started after the assembly step in the routine inspection is completed. As depicted in FIGS. 1 and 5, in the final oil flushing step (Step 4), the operator starts the oil pump 106, and causes the oil delivered from the oil pump 106 to be supplied to the internal pipe 102i through the oil supply pipe 102, to thereby perform oil flushing for the inside of the lubricating oil system 1.

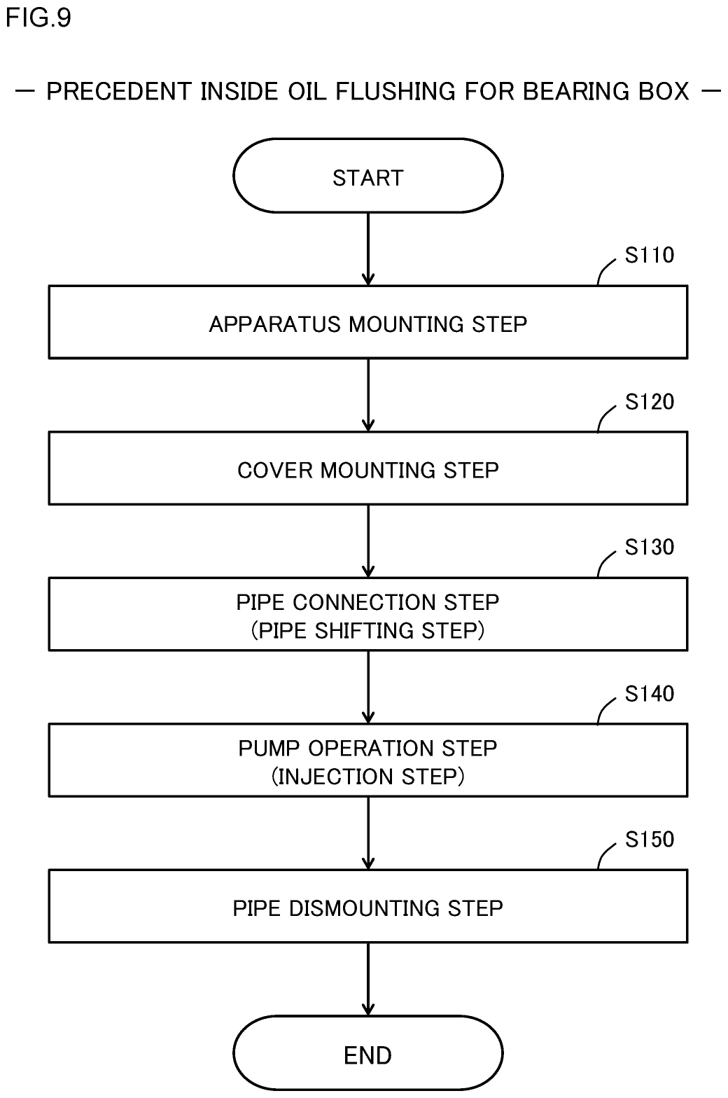

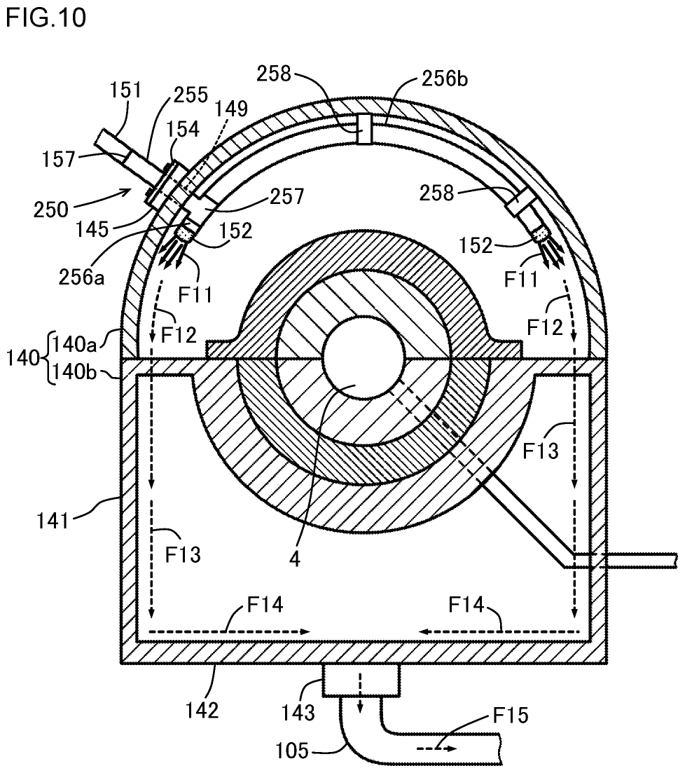

The step of precedent inside oil flushing for bearing box (Step 3) will be described in detail while referring to FIG. 9. FIG. 9 is a flow chart depicting an example of the carrying-out procedure of the step of precedent inside oil flushing for bearing box.

As depicted in FIG. 9, in the step of precedent inside oil flushing for bearing box, an apparatus mounting step S110, a cover mounting step S120, a pipe connection step S130, a pump operation step S140, and a pipe dismounting step S150 are conducted in this order. Steps S110 to S150 are carried out by one or more operators.

### —Apparatus Mounting Step—

An apparatus mounting step S110 is conducted in a state in which the bearing cover 140a is dismounted from the bearing stand 140b. In the apparatus mounting step S110, the operator mounts the flushing apparatus 150 to the bearing cover 140a. Specifically, the operator inserts a tip part of the flushing apparatus 150 into the opening 149 of the bearing cover 140a, and fastens the mounting part 154 to a peripheral edge part of the opening 149 by the fastening members 156. Note that, in a gap between the mounting part 154 and the peripheral edge part of the opening 149, a packing (not illustrated) for sealing the gap is provided. When the apparatus mounting step S110 is completed, the operation proceeds to the cover mounting step S120.

### —Cover Mounting Step—

The cover mounting step S120 is performed in a state in which the upper bearing 3a is mounted to the lower bearing 3b and the upper holding part 5a is mounted to the lower holding part 5b. In the cover mounting step S120, the operator fastens the flange part (not illustrated) of the bearing cover 140a to an upper end part of the bearing stand 140b by fastening members, to thereby mount the bearing cover 140a to the bearing stand 140b. As a result, the bearing box 140 is put into a hermetically sealed state. When the cover mounting step S120 is completed, the operation proceeds to the pipe connection step S130.

### —Pipe Connection Step—

In the pipe connection step S130, the operator connects the bypass pipe 121 to the flushing apparatus 150 through the connection hose 151. Specifically, the operator dismounts one end of the bypass pipe 121 depicted in FIGS. 3A and 3B from the oil discharge pipe 105 and, as depicted in FIG. 6, connects the one end of the bypass pipe 121 to one end of the connection hose 151 through a branch pipe. In addition, as depicted in FIG. 7, the operator connects the other end of the connection hose 151 to a base end part of the tube part 155 of the flushing apparatus 150. In other words, the pipe connection step S130 depicted in FIG. 9 can be said to be a pipe shifting step of shifting the bypass pipe 121 used in the step of precedent inside oil flushing for system (Step 2) from the oil discharge pipe 105 to the flushing apparatus 150.

In addition, in the pipe connection step S130, the operator mounts a foreign material capture member 135 for capturing the foreign material in the oil returned from the bearing box 140 to the oil tank 101 to an oil inlet part of the oil tank 101 (see FIG. 6). Note that, it is sufficient that the foreign material capture member 135 is mounted on an oil return line. Like the above-mentioned foreign material capture member 131, the foreign material capture member 135 is formed by a punching plate, a meshing, or the like. When the pipe connection step S130 is completed, the operation proceeds to a pump operation step S140.

### —Pump Operation Step—

The pump operation step S140 is conducted after the lubricating oil system 1 is put into a hermetically sealed state. In the pump operation step S140, the operator starts the oil pump 106 and, as depicted in FIG. 6, circulates the oil in the flushing system 10 by power of the oil pump 106. When the oil pump 106 is driven, the oil in the oil tank 101 is sucked by the oil pump 106 and is delivered into the oil supply pipe 102.

The oil delivered from the oil pump 106 is supplied to the strainer 103 through the oil supply pipe 102. The strainer 103 captures the foreign material contained in the supplied oil. The oil supplied to the strainer 103 passes through the foreign material capture member 131, is made to flow to the bypass pipe 121, and is introduced to the connection hose 151 through a branch pipe (not illustrated). The oil supplied to the connection hose 151 is introduced to the flushing apparatus 150 and, as depicted in FIG. 7, is injected from the injection holes 153 of the injection nozzle 152 into the bearing box 140.

In short, the pump operation step S140 depicted in FIG. 9 can be said to be an injection step in which the oil is supplied from the oil supply pipe 102 to the flushing apparatus 150 through the bypass pipe 121 by power of the oil pump 106 and the oil is injected from the injection nozzle 152 of the flushing apparatus 150 toward the inner wall surface of the bearing box 140.

As depicted in FIG. 7, the flushing apparatus 150 is mounted to the bearing cover 140a such that the oil is injected from the injection nozzle 152 toward the inner wall surface of the bearing cover 140a and the bearing 3. The oil supplied to the injection nozzle 152 is injected from the plurality of injection holes 153 (see an arrow F11). The oil injected from the injection nozzle 152 collides directly with the inner wall surface of the bearing cover 140a, an inside surface (inner wall surface) 141i of the bearing stand 140b, and the bearing holding member 5.

The oil injected from the injection nozzle 152 toward the inner wall surface of the bearing cover 140a flows down along the inner wall surface (see an arrow F12), and flows down along the inside surface 141i of the bearing stand 140b (see an arrow F13). The oil flowing down along the inside surface 141i is made to flow along a bottom surface 142i by the vigor of dropping (see an arrow F14) and flow through the oil outlet box 143 to the oil discharge pipe 105 (see an arrow F15). Therefore, the oil injected from the injection nozzle 152 toward the inner wall surface of the bearing box 140 washes down the foreign material deposited on the inner wall surface of the bearing box 140. Further, the oil that is made to flow along the bottom surface 142i washes away the foreign material accumulated on the bottom surface 142i toward the oil outlet box 143. In addition, the oil injected from the injection nozzle 152 toward the bearing 3 washes away the foreign material deposited on the bearing holding member 5.

The injection nozzle 152 injects the oil in various directions. Therefore, the foreign material on the whole body inside the bearing box 140 can efficiently be introduced to the oil outlet box 143. The oil flowing from the oil outlet box 143 into the oil discharge pipe 105 is introduced to the oil tank 101. As depicted in FIG. 6, the foreign material capture member 135 is provided at the oil inlet part of the oil tank 101, and, therefore, the foreign material contained in the oil that is returned to the oil tank 101 is captured by the foreign material capture member 135.

In the pump operation step S140, the operator determines whether or not the foreign material in the flushing system 10 has been sufficiently recovered, based on the amount of the foreign material recovered by the foreign material capture member 135 at the oil inlet part of the oil tank 101 and the foreign material capture member 131 of the strainer 103. For example, in a case where the foreign material recovered in a predetermined period is equal to or more than a predetermined amount, it is determined that the foreign material in the flushing system 10 has not been sufficiently recovered, and the pump operation step S140 is continued. In a case where the foreign material recovered in the predetermined period is less than the predetermined amount, it is determined that the foreign material has been sufficiently recovered, the pump operation step S140 depicted in FIG. 9 is finished, and the operation proceeds to the pipe dismounting step S150.

### —Pipe Dismounting Step—

In the pipe dismounting step S150, the operator dismounts the bypass pipe 121 depicted in FIG. 6 from the connection part of the strainer 103. The operator closes the connection part, to which the bypass pipe 121 is connected, of the strainer 103, with a closing member. The operator dismounts the closing plate 132 mounted to the strainer 103 to permit the oil feed pipe 102a and the strainer 103 to communicate with each other. In addition, in the pipe dismounting step S150, the operator dismounts the flushing apparatus 150 from the bearing cover 140a. The operator closes the opening 149 of the bearing cover 140a with a closing plate. As a result, the pipe dismounting step S150 is completed, the step of precedent inside oil flushing for bearing box depicted in FIG. 9 is finished, and the operation proceeds to the final oil flushing step (Step 4) depicted in FIG. 8.

Note that the order of the steps S110 to S150 of the precedent inside oil flushing for bearing box are not limited to those depicted in FIG. 9. For example, the apparatus mounting step S110 may be carried out after the cover mounting step S120 is completed.

According to the embodiment described above, the following advantageous effects are produced.

(1) The flushing method for the lubricating oil system according to the present embodiment includes the step of precedent inside oil flushing for bearing box (Step 3) in which the oil supply pipe 102 and the flushing apparatus 150 mounted to the bearing box 140 are connected to each other by the bypass pipe 121 while bypassing the internal pipe 102i, the oil is supplied from the oil supply pipe 102 to the flushing apparatus 150 through the bypass pipe 121, and the oil is injected from the flushing apparatus 150 into the bearing box 140, whereby oil flushing for the inside of the bearing box 140 is performed; and the final oil flushing step (Step 4) in which the oil is supplied from the oil supply pipe 102 into the internal pipe 102i, whereby oil flushing for the inside of the lubricating oil system 1 is performed, after the step of precedent inside oil flushing for bearing box (Step 3).

As depicted in the lower part of FIG. 8, the step of precedent inside oil flushing for bearing box (Step 3) can be carried out concurrently with the assembly step in the routine inspection. The pump operation step S140 in the step of precedent inside oil flushing for bearing box (Step 3) can be carried out after at least the bearing box 140 is assembled and the lubricating oil system 1 is put into a hermetically sealed state. Therefore, oil flushing can be performed sequentially starting from the bearing box 140 the inspection of the inside of which has been finished and the assembly of which has been completed.

While the pump operation step S140 is being carried out, assembly work of other component parts, such as, for example, assembly work of coupling for connecting the rotors 4 of a plurality of turbines 2 (for example, the rotors of a low-pressure turbine and a high-pressure turbine) to each other, or coupling for the rotor 4 of the turbine 2 and a rotor of a generator, can be performed. By adjusting the steps such that the step of precedent inside oil flushing for bearing box (Step 3) for each bearing box 140 is completed at the time point when the assembly step in the routine inspection is completed, transit to the final oil flushing step (Step 4) can be conducted smoothly.

In Comparative Example depicted in the upper part of FIG. 8, the step of precedent inside oil flushing for bearing box (Step 3) is not carried out. Therefore, it is necessary to recover the foreign material in the bearing box 140 by the final oil flushing step (Step 4), so that the time required for the final oil flushing step is prolonged. On the other hand, in the present embodiment, prior to the final oil flushing step (Step 4), the step of precedent inside oil flushing for bearing box (Step 3) in which the oil from the flushing apparatus 150 is injected into the bearing box 140 is carried out. As a result, the foreign material in the bearing box 140 can be recovered swiftly in the step of precedent inside oil flushing for bearing box (Step 3), and the final oil flushing step (Step 4) can be shortened by a period on the order of 0.5 day as compared to Comparative Example. As a result, the routine inspection can be shortened by a period on the order of 0.5 day.

(2) The flushing method for the lubricating oil system according to the present embodiment further includes, prior to the step of precedent inside oil flushing for bearing box (Step 3), the step of precedent inside oil flushing for system (Step 2) in which the oil supply pipe 102 and the oil discharge pipe 105 are connected to each other by the bypass pipe 121 while bypassing the bearing box 140, and the oil delivered from the oil pump 106 is returned to the oil tank 101 through the oil supply pipe 102, the bypass pipe 121, and the oil discharge pipe 105, whereby oil flushing for the inside of the lubricating oil system 1 is performed. In the step of precedent inside oil flushing for bearing box (Step 3), the bypass pipe 121 used in the step of precedent inside oil flushing for system (Step 2) is mounted to the flushing apparatus 150, and the oil supplied to the flushing apparatus 150 through the bypass pipe 121 is injected from the injection nozzle 152.

According to this method, the step of precedent inside oil flushing for system (Step 2) is carried out prior to the step of precedent inside oil flushing for bearing box (Step 3), whereby the final oil flushing step (Step 4) can be shortened, as compared to the case where the step of precedent inside oil flushing for system (Step 2) is not carried out. In addition, in this method, the same bypass pipe 121 is used in the step of precedent inside oil flushing for system (Step 2) and in the step of precedent inside oil flushing for bearing box (Step 3), and, therefore, the number of component parts used for carrying out the flushing method can be reduced, and the transit from the step of precedent inside oil flushing for system (Step 2) to the step of precedent inside oil flushing for bearing box (Step 3) can be performed smoothly. Further, in this method, in the step of precedent inside oil flushing for bearing box (Step 3), the oil in the oil tank 101 that is preliminarily purified can be supplied to the flushing apparatus 150. Therefore, inflow of the foreign material into the flushing apparatus 150 can be prevented, so that the oil can properly be injected from the flushing apparatus 150.

(3) The step of precedent inside oil flushing for bearing box (Step 3) includes the apparatus mounting step S110 of mounting the flushing apparatus 150 to the bearing cover 140a; the cover mounting step S120 of mounting the bearing cover 140a to the bearing stand 140b; the pipe connection step S130 of connecting the bypass pipe 121 to the flushing apparatus 150; and the injection step (pump operation step) S140 of supplying the oil from the oil supply pipe 102 to the flushing apparatus 150 through the bypass pipe 121 and injecting the oil from the injection nozzle 152 of the flushing apparatus 150 toward the inner wall surface of the bearing box 140. In a case where the apparatus mounting step S110 is carried out prior to the cover mounting step S120, the flushing apparatus 150 can be mounted to the bearing cover 140a concurrently with the inspection of the bearing 3. In addition, since the flushing apparatus 150 is mounted to the bearing cover 140a, the oil can be injected from above the bearing 3 and the bearing stand 140b. As a result, the bearing 3 and the bearing stand 140b can effectively be cleaned.

(4) The flushing apparatus 150 is mounted to the bearing cover 140a such that the oil is injected from the injection nozzle 152 toward the inner wall surface of the bearing cover 140a. The oil injected toward the inner wall surface of the bearing cover 140a flows down along the inside surface (inner wall surface) 141i of the bearing stand 140b. In short, the flushing apparatus 150 is mounted to the bearing cover 140a such that the oil injected from the injection nozzle 152 flows down along the inside surface 141i of the bearing stand 140b. As a result, the foreign material deposited on the inner wall surface of the bearing cover 140a and the inside surface (inner wall surface) 141i of the bearing stand 140b and the foreign material accumulated on the bottom surface 142i of the bearing stand 140b can efficiently be recovered.

(5) The flushing apparatus 150 is mounted to the bearing cover 140a such that the oil is injected from the injection nozzle 152 toward the bearing 3. As a result, the foreign material deposited on the bearing holding member 5 for holding the bearing 3 can efficiently be recovered.

(6) The flushing apparatus 150 has the rectilinear tube part 155, the oil inlet part 157 is provided on the base end side of the tube part 155, and the injection nozzle 152 is provided on the tip side of the tube part 155. The mounting part 154 is provided such as to project to outside from the tube part 155. In this configuration, by mounting the mounting part 154 to the bearing cover 140a, the injection nozzle 152 is positioned. Therefore, positioning of the injection nozzle 152 can easily be conducted. In addition, the flushing apparatus 150 can easily be mounted to and dismounted from the bearing cover 140a.

(7) The flushing system 10 includes the oil tank 101 in which the oil is reserved; the oil pump 106 that sucks the oil in the oil tank 101 and delivers the oil; the bearing box 140 accommodating the bearing 3 of the turbine 2; the oil supply pipe 102 that is connected to the oil tank 101 and the bearing box 140 and supplies the oil delivered from the oil pump 106 to the bearing box 140; the oil discharge pipe 105 that is connected to the bearing box 140 and the oil tank 101 and introduces the oil discharged from the bearing box 140 to the oil tank 101; the foreign material capture member 135 that captures the foreign material contained in the oil returned from the bearing box 140 to the oil tank 101; and the bypass pipe 121 that is connected to the oil supply pipe 102 and the flushing apparatus 150 while bypassing the internal pipe 102i in the bearing box 140, the internal pipe 102i introducing the oil supplied from the oil supply pipe 102 to a part between the rotor 4 of the turbine 2 and the bearing 3. By performing oil flushing by this flushing system 10, the foreign material in the bearing box 140 can swiftly be recovered, and the final oil flushing step which is the next step can be shortened.

The following modifications are also in the scope of the present invention, and it is possible to combine the configurations described in the modifications and the configurations described in the above embodiment and to combine the configurations described in the following different modifications.

### <Modification 1>

An example in which the flushing apparatus 150 has the rectilinear tube part 155, the injection nozzle 152 is provided at a tip part of the tube part 155, and the injection nozzle 152 is disposed on the center axis of the opening 149 of the bearing cover 140a has been described in the above embodiment, but the present invention is not limited to this. The injection nozzle 152 can be disposed at a desired position. A flushing apparatus 250 according to Modification 1 of the above embodiment will be described referring to FIG. 10.

FIG. 10 is a side sectional schematic view of the bearing box 140, and is a drawing depicting the flushing apparatus 250 according to Modification 1 of the present embodiment. As depicted in FIG. 10, the flushing apparatus 250 according to this modification has a rectilinear tube part 255, a pipe mounting part 257 provided at a tip part of the tube part 255, a mounting part 154 provided such as to project to outside from the tube part 255, pipes having flexibility (hereinafter referred to as flexible pipes) 256a and 256b such as hoses mounted to the pipe mounting part 257, and injection nozzles 152 provided at tip parts of the flexible pipes 256a and 256b, and the injection nozzles 152 are disposed at positions different from positions on the center axis of the opening 149.

In this modification, as depicted in the drawing, the two flexible pipes 256a and 256b are mounted to the pipe mounting part 257 provided at a tip part of the tube part 255. The pipe mounting part 257 is configured as a T-shaped branch part such that the oil supplied from the oil inlet part 157 to the tube part 255 can be distributed to the flexible pipe 256a on one side and the flexible pipe 256b on another side.

The flexible pipe 256b is mounted to an inner wall surface of the bearing cover 140a by a mounting member 258. In this configuration, the injection nozzles 152 can easily be set at desired positions by the flexible pipes 256a and 256b. Therefore, the injection nozzles 152 can be fixed at positions and angles such that the oil can be injected to places where the foreign material is liable to be accumulated in the bearing stand 140b. In addition, since the injection nozzles 152 can be set at freely-selected positions, it is possible, by causing the oil to flow to the whole part of the bearing stand 140b, to efficiently recover the foreign material. Note that an example in which the flexible pipes 256a and 256b are disposed along the circumferential direction of the bearing cover 140a is depicted in FIG. 10, but the flexible pipes 256a and 256b may be disposed along the axial direction of the rotor 4.

The flexible pipes 256a and 256b, the pipe mounting part 257, and the injection nozzles 152 are formed such as to be able to pass through the opening 149 of the bearing cover 140a. In the pipe dismounting step S150, the operator dismounts the mounting part 154 from the pipe stand 145, and pulls the tube part 255 out of the opening 149, whereby the flexible pipes 256a and 256b, the pipe mounting part 257, and the injection nozzles 152 can be taken out of the bearing box 140. Note that the mounting member 258 is configured such as to be dismounted from the inner wall surface of the bearing cover 140a by pulling the tube part 255.

### <Modification 2>

An example (see FIG. 7) in which the injection nozzles 152 inject the oil toward the inner wall surface of the bearing cover 140a and the bearing 3 has been described in the above embodiment, but the present invention is not limited to this. For example, the injection nozzles 152 may be configured to inject the oil only toward one of the inner wall surface of the bearing cover 140a and the bearing 3. In addition, the injection nozzles 152 can be configured to inject the oil only toward the inside surface 141i of the bearing stand 140b.

### <Modification 3>

An example in which the present invention is applied to the lubricating oil system 1 of the bearing 3 in a steam turbine has been described in the above embodiment, but the present invention is not limited to this. The present invention may be applied to a lubricating oil system of a bearing in a gas turbine. The present invention is applicable to a lubricating oil system of the bearing 3 supporting the turbine 2, such as a bearing provided between a plurality of turbines or a bearing provided between a turbine and a generator.

### <Modification 4>

An example in which the flushing method according to the above embodiment includes the step of precedent inside oil flushing for tank (Step 1), the step of precedent inside oil flushing for system (Step 2), the precedent inside oil flushing for bearing box (Step 3), and the final oil flushing (Step 4) has been described above, but the present invention is not limited to this. One or both the step of precedent inside oil flushing for tank (Step 1) and the step of precedent inside oil flushing for system (Step 2) may be omitted.

### <Modification 5>

An example in which the bypass pipe 121 used in the step of precedent inside oil flushing for system (Step 2) is connected to the flushing apparatus 150 for the bearing box 140 and is also used in the step of precedent inside oil flushing for bearing box (Step 3) has been described in the above embodiment, but the present invention is not limited to this. In the step of precedent inside oil flushing for bearing box (Step 3), a bypass pipe different from the bypass pipe used in the step of precedent inside oil flushing for system (Step 2) may be connected to the strainer 103 and the flushing apparatus 150 for the bearing box 140.

### <Modification 6>

An example in which the bypass pipe 121 is connected to the strainer 103 and the flushing apparatus 150 for the bearing box 140 has been described in the above embodiment, but the present invention is not limited to this. The flushing system 10 may have a configuration in which the oil feed pipe 102a connecting the strainer 103 and the bearing box 140 to each other and the flushing apparatus 150 for the bearing box 140 are connected to each other by the bypass pipe 121. In this case, a closing member for interrupting the flow of the oil is mounted between the connection part of the bypass pipe 121 in the oil feed pipe 102a and the internal pipe 102i.

### <Modification 7>

An example in which the injection nozzle 152 is provided with a plurality of injection holes 153 has been described in the above embodiment, but the present invention is not limited to this. The injection nozzle 152 may has a single injection hole. As a result, the injection nozzle 152 can inject the oil locally.

### <Modification 8>

An example in which the flushing apparatus 150 is dismounted from the bearing cover 140a in the pipe dismounting step S150 has been described in the above embodiment, but the present invention is not limited to this. The flushing apparatus 150 may be left mounted. In this case, in the pipe dismounting step S150, the operator dismounts the connection hose 151 from the flushing apparatus 150, and closes the oil inlet part 157 of the tube part 155 by a closing member. According to this modification, the flushing apparatus 150 can be used also at the time of a next-time routine inspection.

While the embodiment of the present invention has been described above, the embodiment merely represents a part of an application example of the present invention, and is not intended to limit the technical scope of the present invention to the specific configurations of the above embodiment.

### DESCRIPTION OF REFERENCE CHARACTERS

1: Lubricating oil system
2: Turbine
3: Bearing
4: Rotor
5: Bearing holding member
10: Flushing system
101: Oil tank
102: Oil supply pipe
102i: Internal pipe
103: Strainer
105: Oil discharge pipe
106: Oil pump
121: Bypass pipe
122: Strainer
131: Foreign material capture member
132: Closing plate
135: Foreign material capture member
140: Bearing box
140a: Bearing cover
140b: Bearing stand
141: Side plate
141i: Inside surface (inner wall surface)
142: Bottom plate
142i: Bottom surface
143: Oil outlet box
144: Support plate
145: Pipe stand
149: Opening
150: Flushing apparatus
151: Connection hose
152: Injection nozzle
153: Injection hole
154: Mounting part
155: Tube part
156: Fastening member
157: Oil inlet part
190: Oil purifier
250: Flushing apparatus
255: Tube part
256a, 256b: Flexible pipe
257: Pipe mounting part
258: Mounting member

What is claimed is:

1. A flushing method for a lubricating oil system of a turbine in a power generation plant,
the lubricating oil system having an oil tank in which an oil is reserved, an oil pump that sucks the oil in the oil tank and delivers the oil, a bearing box accommodating a bearing of the turbine, an oil supply pipe that is connected to the oil tank and the bearing box and supplies the oil delivered from the oil pump to the bearing box, an internal pipe that is provided in the bearing box and introduces the oil supplied from the oil supply pipe to a part between a rotor of the turbine and the bearing, an oil discharge pipe that is connected to the bearing box and the oil tank and introduces the oil discharged from the bearing box to the oil tank, and a strainer provided in the oil supply pipe,
the flushing method comprising:
a step of performing precedent inside oil flushing for bearing box, by connecting the oil supply pipe and a flushing apparatus mounted to the bearing box to each other by a bypass pipe while bypassing the internal pipe, supplying the oil from the oil supply pipe to the flushing apparatus through the bypass pipe, and injecting the oil from the flushing apparatus into the bearing box, to thereby perform oil flushing for an inside of the bearing box; and
a final oil flushing step of supplying oil from the oil supply pipe to the internal pipe, to thereby perform oil flushing for an inside of the lubricating oil system, after the step of performing precedent inside oil flushing for bearing box.

2. The flushing method for the lubricating oil system according to claim 1, further comprising:
a step of performing precedent inside oil flushing for system, prior to the step of performing precedent inside oil flushing for bearing box, by connecting the oil supply pipe and the oil discharge pipe by the bypass pipe while bypassing the bearing box, and returning the oil delivered from the oil pump through the oil supply pipe, the bypass pipe, and the oil discharge pipe to the oil tank, to thereby perform oil flushing for the inside of the lubricating oil system.

3. The flushing method for the lubricating oil system according to claim 1,
wherein the bearing box has a bearing stand that supports the bearing from a lower side and a cover that is provided on the bearing stand and covers the bearing, and
the step of performing precedent inside oil flushing for bearing box includes
an apparatus mounting step of mounting the flushing apparatus to the cover,
a cover mounting step of mounting the cover to the bearing stand,
a pipe connection step of connecting the bypass pipe to the flushing apparatus, and
an injection step of supplying the oil from the oil supply pipe to the flushing apparatus through the bypass pipe and injecting the oil from an injection nozzle of the flushing apparatus toward an inner wall surface of the bearing box.

4. The flushing method for the lubricating oil system according to claim 3,
wherein the flushing apparatus is mounted to the cover such that the oil is injected from the injection nozzle toward an inner wall surface of the cover.

5. The flushing method for the lubricating oil system according to claim 3,
wherein the flushing apparatus is mounted to the cover such that the oil is injected from the injection nozzle toward the bearing.

6. A flushing apparatus used for carrying out a flushing method for a bearing box having a bearing stand that supports a bearing of a turbine in a power generation plant from a lower side and a cover that is provided on the bearing stand and covers the bearing, the flushing apparatus comprising:
a mounting part mounted to the cover;
an oil inlet part supplied with an oil; and
an injection nozzle that injects the oil supplied to the oil inlet part into the bearing box,
wherein the oil is injected from the injection nozzle into the bearing box, to thereby perform oil flushing for an inside of the bearing box.

7. The flushing apparatus according to claim 6,
wherein the flushing apparatus is mounted to the cover such that the oil injected from the injection nozzle flows down along an inside surface of the bearing stand.

8. The flushing apparatus according to claim 6,
wherein the flushing apparatus is mounted to the cover such that the oil is injected from the injection nozzle toward an inner wall surface of the cover.

9. The flushing apparatus according to claim 6,
wherein the flushing apparatus is mounted to the cover such that the oil is injected from the injection nozzle toward the bearing.

10. The flushing apparatus according to claim 6, further comprising:
a rectilinear tube part,
wherein the oil inlet part is provided on a base end side of the tube part,
the injection nozzle is provided on a tip side of the tube part, and
the mounting part is provided such as to project to outside from the tube part.

11. The flushing apparatus according to claim 6, further comprising:
a flexible pipe that has flexibility and is provided at a tip part thereof with the injection nozzle; and
a pipe mounting part to which the flexible pipe is mounted.

12. A flushing system comprising:
the flushing apparatus according to claim 6;
an oil tank in which an oil is reserved;
an oil pump that sucks the oil in the oil tank and delivers the oil;
the bearing box that accommodates the bearing of the turbine;
an oil supply pipe that is connected to the oil tank and the bearing box and supplies the oil delivered from the oil pump to the bearing box;
an oil discharge pipe that is connected to the bearing box and the oil tank and introduces the oil discharged from the bearing box to the oil tank;
a foreign material capture member that captures a foreign material in the oil returned from the bearing box to the oil tank; and
a bypass pipe connected to the oil supply pipe and the flushing apparatus while bypassing an internal pipe in the bearing box that introduces the oil supplied from the oil supply pipe to a part between a rotor of the turbine and the bearing.
